(19) United States
(12) Patent Application Publication
(10) Pub. No.: US 2006/0118672 A1
(43) Pub. Date: Jun. 8, 2006

(54) Non-rotatable fan tool and fan tool-holder assembly

(76) Inventors: Jeffrey T. Hickey, Bedford, PA (US); Duane E. Carson JR., Hollidaysburg, PA (US)

Correspondence Address: KENNAMETAL INC., P.O. BOX 231, 1600 TECHNOLOGY WAY, LATROBE, PA, 15650, US

(21) Appl. No.: 11/005,510

(22) Filed: Dec. 6, 2004

(51) Int. Cl. B02C 13/28

(52) U.S. Cl. 241/294

(57) ABSTRACT

A non-rotatable fan tool includes a head portion and a shank portion. The head portion has a support member and a wear member integral with the support member. The support member further has a rear surface from which there protrudes a protrusion. The wear member extends over the protrusion. The shank portion has an axial forward end. The shank portion is attached at the axial forward end thereof to the rear surface of the head portion.

### BACKGROUND OF THE INVENTION

The invention pertains to a fan tool used in the recycling industry. More specifically, the invention relates to a non-rotatable fan tool, as well as a fan tool-holder assembly, used in the recycling industry and more particularly in the organic recycling industry.

Heretofore, wear-resistant tools typically termed fan tools have been used in recycling equipment to help process the recyclable material. In the case of equipment used to recycle organic materials, e.g., leaves, brush and other tree material, fan tools are typically installed in the drum-mounted holders so that upon rotation of the drum, the fan tools provide a fan-style of action to assist the movement of the organic material through screens during the processing of the material. An example of a tool holder is shown in U.S. Pat. No. 6,047,912 to Smith.

During operation, the fan tool has an orientation such that it contacts the material straight on so as to eliminate the potential for wear on the side surfaces of the fan tool. When the fan tool contacts the material in a straight on orientation, it effectively pushes the material into the screens. For a number of reasons, it is important that the fan tool remains in the straight on orientation throughout the life cycle of the fan tool. If the fan tool rotates so as to lose the straight on orientation, the steel body experiences additional wear which can result in premature failure due to erosion of the steel body. If the fan tool becomes loose during the operation, there is the potential that the shank of the fan tool will break or the entire fan tool will work itself free of the holder. Obviously, a broken or dislodged fan tool reduces the efficiency of the recycling equipment. In addition, a broken or dislodged fan tool may continue through the recycling equipment so as to damage the equipment. It can thus be appreciated that it is important to be able to provide a fan tool that presents a correct straight-on orientation with respect to the recyclable material. It is also important to provide a fan tool that can effectively resist rotation, and remain intact and productive during the operation of the recycling equipment.

Current fan tools comprise a cast-in-carbide steel bar that is shimmed to the appropriate attack angle and then welded to a threaded shank. Because the shimming must be done for each tool, there is the potential that the current shimmed fan tool may present a wear surface at an incorrect attack angle. This is an undesirable characteristic of the current fan tools. Current fan tools do not have any feature that resists the rotation of the fan tool during operation. This too is an undesirable characteristic of the current fan tools.

It thus would be desirable to provide an improved fan tool that provides for the consistent orientation of the wear surface with respect to the recyclable material during operation. It would also be highly desirable to provide an improved fan tool that has the capability to resist rotation during operation in the recycling equipment.

### SUMMARY OF THE INVENTION

In one form thereof, the invention is a non-rotatable fan tool comprises a head portion and a shank portion wherein the head portion has a support member and a wear member integral with the support member. The support member has a rear surface from which there protrudes a protrusion. The wear member extends over the protrusion. The shank portion has an axial forward end. The shank portion is attached at the axial forward end thereof to the rear surface of the head portion.

In still another form thereof, the invention is a non-rotatable fan tool-holder assembly for attachment to a rotatable drum. The assembly comprises a holder that has a forward face that presents an abutment. The fan tool comprises a head portion and a shank portion. The head portion has a support member and a wear member integral with the support member. The support member has a rear surface from which there protrudes a protrusion when the fan tool and the holder are assembled the abutment engages the protrusion so as to render the fan tool non-rotatable with respect to the holder. The wear member extends over the protrusion. The shank portion has an axial forward end. The shank portion is attached at the axial forward end thereof to the rear surface of the head portion.

In yet another form thereof, the invention is a fan tool for use in conjunction with a tool holder containing a notch. The fan tool comprises a head portion and a shank portion. The head portion has a support member and a wear member containing hard particles. The wear member is integral with the support member. The support member has a rear surface from which there protrudes a protrusion wherein the protrusion engages the notch so as to render the fan tool non-rotatable with respect to the holder. The wear member extends over the protrusion. The shank portion has an axial forward end. The shank portion is attached at the axial forward end thereof to the rear surface of the head portion. The wear member has a generally planar forward face. The shank portion has a longitudinal axis. The forward face of the wear member is disposed at an included angle with respect to the longitudinal axis of the shank portion wherein the included angle ranges between about 0 degrees and about 90 degrees.

### BRIEF DESCRIPTION OF THE DRAWINGS

The following is a brief description of the drawings that accompany and form a part of this patent application:

FIG. 1 is an isometric view of a specific embodiment of the fan tool—tool holder assembly wherein the fan tool is positioned within the bore of the tool holder so as to show the relationship between the fan tool and the tool holder;

FIG. 2 is a side view of the fan tool-tool holder assembly of FIG. 1 with a portion of the tool holder cut away so as to expose the shank of the fan tool positioned within the bore of the tool holder;

FIG. 3 is a view of the fan tool-tool holder assembly taken from section line 3-3 of FIG. 2;

FIG. 4 is a bottom view of the fan tool—tool holder assembly of FIG. 1;

FIG. 5 is an isometric view of the specific embodiment of the fan tool of FIG. 1;

FIG. 6 is a side view of the specific embodiment of the fan tool of FIG. 1;

FIG. 7 is a side view of the wear portion of the fan tool of FIG. 1;

FIG. 8 is an end view of the wear portion of the fan tool of FIG. 1;

FIG. 9 is an isometric view of another specific embodiment of the fan tool—tool holder assembly wherein the fan tool is positioned within the bore of the tool holder so as to show the relationship between the fan tool and the tool holder; and

FIG. 10 is a front view of the fan tool—tool holder assembly of FIG. 9.

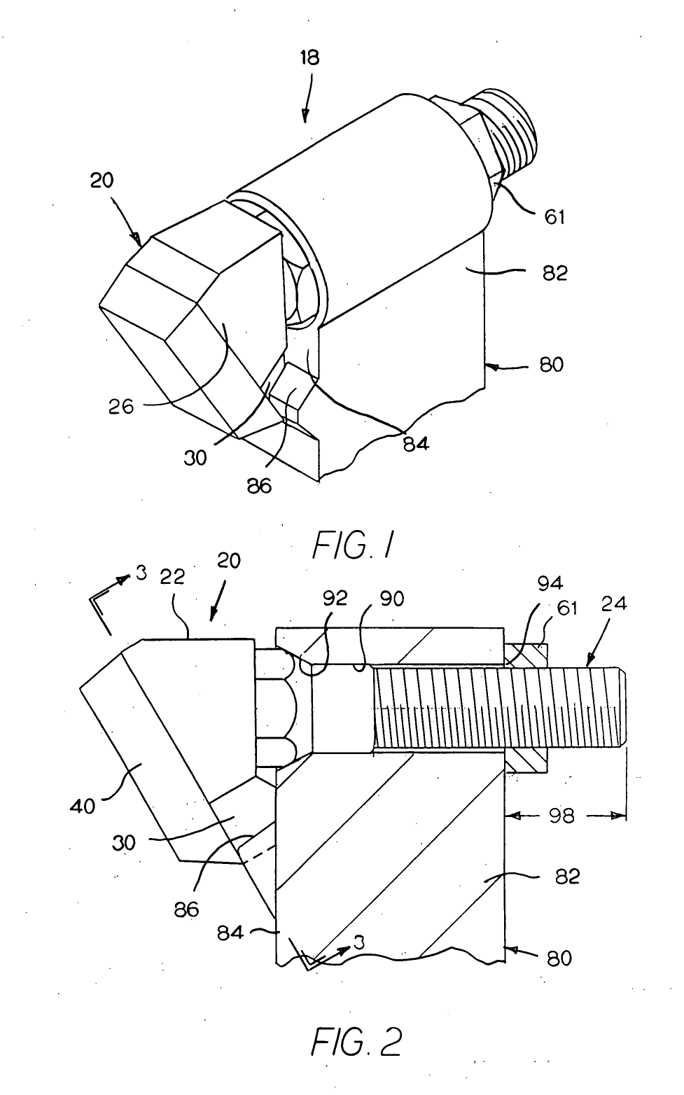

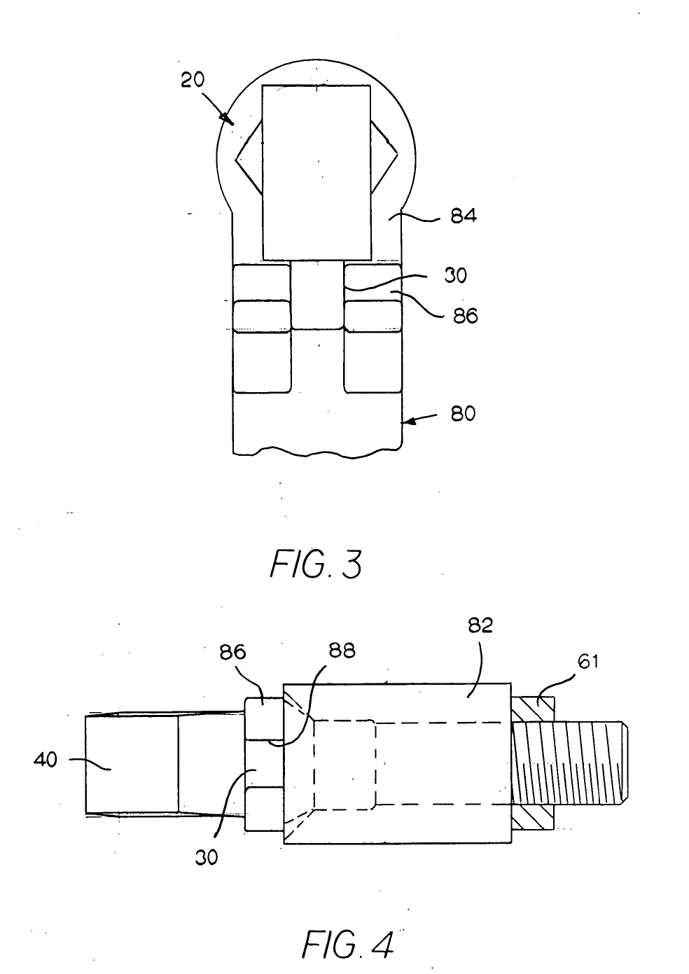

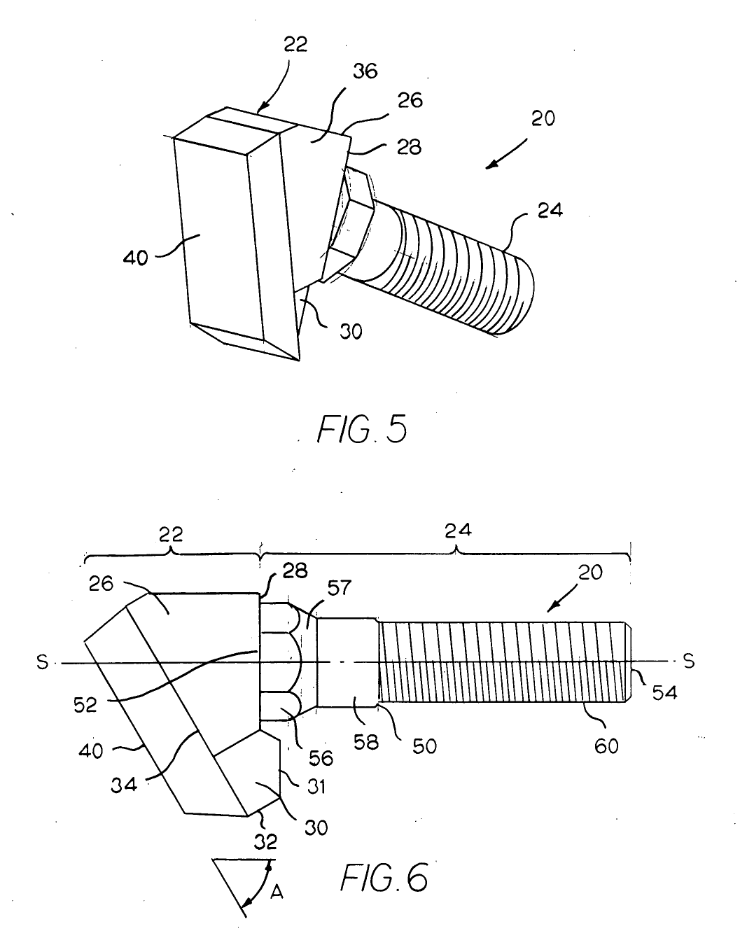

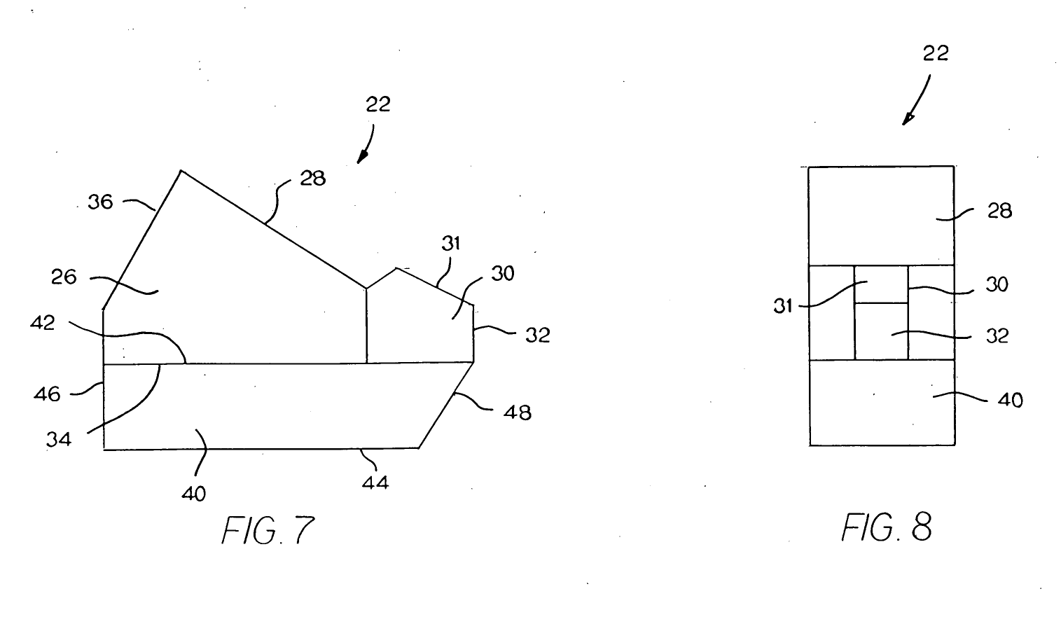

### DETAILED DESCRIPTION OF THE INVENTION

Referring to the drawings, there is shown an assembly of a fan tool and tool holder wherein the fan tool—tool holder assembly is generally designated as 18. The fan tool—tool holder assembly 18 includes a fan tool generally designated as 20 and a tool holder generally designated as 80.

In regard to the fan tool 20, fan tool 20 has an axial forward head portion 22 and a generally cylindrical axial rearward shank portion 24. The head portion 22 includes a support member 26. Support member 26 has a rear surface 28 as well as a protrusion 30 extending in a rearward direction from the rear surface 28. The protrusion 30 has a rear surface 31 and a side exposed surface 32. Support member 26 also has a forward surface 34 and a side surface 36.

The head portion 22 of the fan tool 20 also includes a cast-in wear member 40. Wear member 40 has a rear termination 42, a forward surface (i.e., a generally planar forward face) 44, one side surface 46, and another side surface 48. Wear member 40 is cast as an integral part of the head portion 22 wherein the technique for making such a cast-in member is, for example, shown and described in U.S. Pat. No. 4,608,318 to Makrides et al. and U.S. Pat. No. 5,066,546 to Materkowski wherein U.S. Pat. No. 4,608,318 and U.S. Pat. No. 5,066,546 are hereby incorporated by reference herein.

Typically, the support member 26 is made from steel or a like material wherein the support member 26 provides support to the wear member 40. The wear member 40 is typically made from a hard material such as a cemented carbide or a metal matrix with hard (e.g., cemented carbides or carbide) particles distributed throughout. A suitable commercialized process for producing the head portion 22 is the Kencast™ process available from Kennametal Inc. of Latrobe, Pa. 15650 (the assignee of the present patent application).

The wear member 40 extends to such an extent that it extends over the protrusion 30. By extending over the protrusion 30, the wear member 40 provides protection to the protrusion 30 (which is typically made of softer, less wear resistant material than the material of the wear member 40) against abrasion caused by impingement of the material to be recycled on the protrusion 30.

The fan tool 20 further includes an elongate shank 50. Shank 50 has an axial forward end 52 and an opposite axial rearward end 54. Moving in the axial rearward direction, the shank 50 presents a hexagonal-shaped nut portion 56, a frusto-conical smooth transition portion 57, a cylindrical smooth transition portion 58 and a threaded portion 60 that terminates at the axial rearward end 54 of the shank 50. The smooth transition portions (57 and 58) provide a transition between the nut portion 56 and the threaded shank portion 60.

To fabricate the fan tool 20, the head portion 22 is welded at its rear surface 28 to the axial forward end 52 of the shank 50. Using this fabrication technique, does not require that the head be shimmed or otherwise altered or adjusted to create the attack angle for the wear member 40. Instead, the attack angle of the wear member 40 is already built into the head portion 22 due to the orientation of the wear member 40 relative to the rear surface 28. The included angle “A” (see FIG. 6) between the generally planar forward surface 44 of the wear member 40 and the longitudinal axis S-S of the shank portion 50 is about 60 degrees, and included angle “A” can range between about 0 degrees and about 90 degrees. As an alternate range, the included angle “A” can range between about 30 degrees and about 75 degrees.

This type of assembly thus provides for a much more consistent and reliable attack angle for the wear member 40 of the fan tool 20. The fabrication technique for fan tool 20 provides for a more consistent attack angle, and hence, results in a fan tool 20 that has a more consistent orientation upon impact (or impingement) with respect to the recyclable material. As previously mentioned, a fan tool that has a more consistent and reliable orientation upon impact with respect to the recyclable material will better maintain its integrity during operation.

Tool holder 80 has a body 82. Body 82 of the holder 80 contains a forward face 84 that includes a projection 86 that projects in a forward direction from the forward face 84. The projection 86 contains a notch 88 (that defines an abutment) therein. The body 82 further contains a bore 90 therein. The bore 90 has a frusto-conical surface 92 at the forward end and a cylindrical surface that terminates in a rear end 94.

In reference to the assembly of the fan tool 20 to the tool holder 80, the shank 24 of the fan tool 20 is passed through the bore 90. The frusto-conical transition 57 on the shank 24 contacts the frusto-conical surface 92 of the bore 90. A rearward length (shown by brackets 98) of the shank 24 extends rearwardly of the holder 80. The protrusion 30 is received in the notch 88 so as to engage one another (i.e., the abutment engages the protrusion) and thereby function to restrain the fan tool 20 from rotational movement relative to the holder 80.

The fan tool 20 is fastened (or attached) to the fan tool—tool holder assembly 18 by a nut 61 that is threadedly engaged to the threaded portion 60 of the shank 50. Because of the non-rotatable relationship between the fan tool 20 and the tool holder 22, the nut 61 may be tightly turned so that the fan tool 20 is securely fastened to the holder 80. More specifically, the positive engagement between the fan tool 20 and the holder 80 allows the operator to apply more torque to the nut 61, and hence, better tighten the fan tool 20 to the holder 80. The fact that the fan tool 20 is better tightened to the holder 80 enhances the ability of the fan tool 20 to not rotate, and thereby enhances its potential maintain its original orientation with respect to the recyclable material during operation. The tool holder 80 is attached to the rotatable drum that is a part of the recycling equipment.

As mentioned above, the ability of the fan tool 20 to not rotate during operation provides meaningful advantages. The non-rotatable capability of the fan tool 20 allows the orientation of the fan tool 20 to the recyclable material to remain constant. The non-rotatable capability of the fan tool 20 also reduces the potential that the fan tool 20 will break wherein such breakage can reduce the efficiency of the recycling equipment as well as damage the recycling equipment.

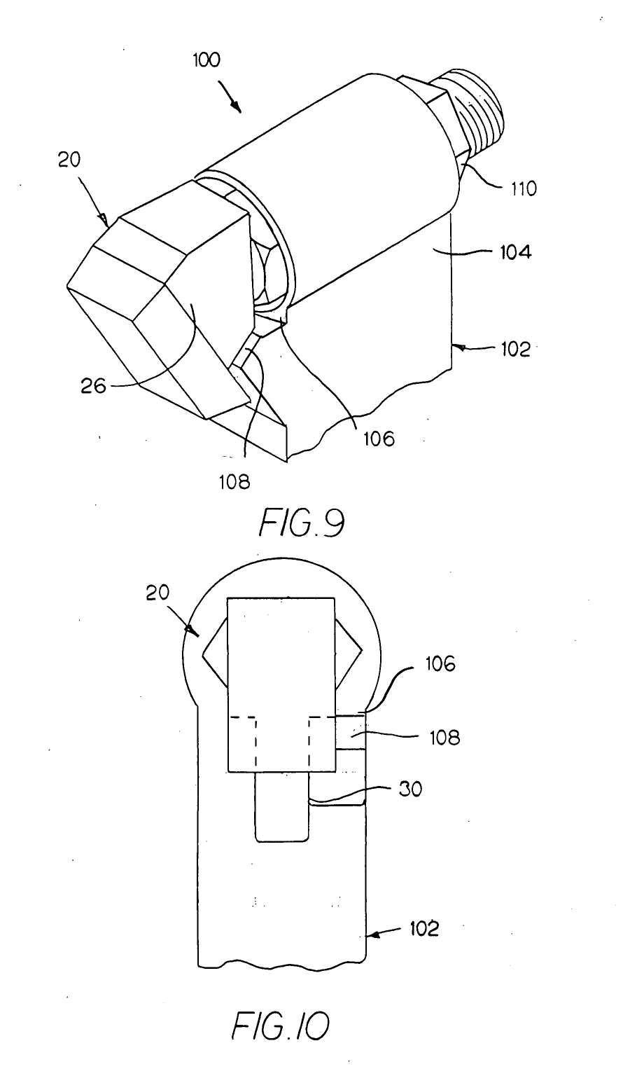

Referring to FIGS. 9 and 10, there is shown another specific embodiment of the fan tool-holder arrangement generally designated as 100. The structure of the fan tool in this embodiment is the same as fan tool 20, and thus, is referred to by the same reference numerals as used hereinabove in conjunction with the description of fan tool 20. The holder is generally designated as 102. Holder 102 has a body 104 that has a forward face 106 that includes a single projection 108 (or abutment) on the right side (as one looks toward the front) of the forward face 106. There is a nut 110 threadedly connected to the threaded portion 60 of the shank 50 so as to tighten the fan tool 20 to the holder 102.

Like for the first embodiment of the fan tool-holder assembly 18, in the second embodiment of the fan tool-holder assembly 100, there is an advantage for the fan tool 20 to not be able to rotate so as to become loose once it is attached to the holder 102. In order to achieve this condition, projection 108 is located to the right (as one looks toward the front) of the fan tool 20 so that the fan tool 20 abuts against the projection 108 (i.e., the abutment engages the protrusion) and prevents the fan tool 20 from rotating in a direction that will cause it to become loosened from the holder 102.

It can thus be appreciated that the present invention provides an improved fan tool that provides for the maintenance of the original orientation of the wear surface with respect to the recyclable material throughout the operation of the recycling equipment. The present invention also provides an improved fan tool that has the capability to resist rotational movement (and thereby maintain its original orientation) throughout the operation of the recycling equipment.

The patents and other documents identified herein are hereby incorporated by reference herein. Other embodiments of the invention will be apparent to those skilled in the art from a consideration of the specification or a practice of the invention disclosed herein. It is intended that the specification and examples are illustrative only and are not intended to be limiting on the scope of the invention. The true scope and spirit of the invention is indicated by the following claims.

What is claimed is:

1. A non-rotatable fan tool comprising:
a head portion and a shank portion;
the head portion having a support member and a wear member integral with the support member, the support member having a rear surface from which there protrudes a protrusion;
the wear member extending over the protrusion;
the shank portion having an axial forward end; and
the shank portion being attached at the axial forward end thereof to the rear surface of the head portion.

2. The non-rotatable fan tool of claim 1 wherein the wear member comprises hard material.

3. The non-rotatable fan tool of claim 1 wherein the wear member having a generally planar forward face, the shank portion having a longitudinal axis, and the forward face of the wear member being disposed at an included angle with respect to the longitudinal axis of the shank portion.

4. The non-rotatable fan tool of claim 3 wherein the included angle ranges between about 0 degrees and about 90 degrees.

5. The non-rotatable fan tool of claim 3 wherein the included angle ranges between about 30 degrees and about 75 degrees.

6. A non-rotatable fan tool-holder assembly for attachment to a rotatable drum, the assembly comprising:
a holder having a forward face presenting an abutment;
a fan tool comprising:
a head portion and a shank portion;
the head portion having a support member and a wear member integral with the support member, the support member having a rear surface from which there protrudes a protrusion when the fan tool and the holder are assembled the abutment engaging the protrusion so as to render the fan tool non-rotatable with respect to the holder;
the wear member extending over the protrusion;
the shank portion having an axial forward end; and
the shank portion being attached at the axial forward end thereof to the rear surface of the head portion.

7. The non-rotatable fan tool-holder assembly of claim 6 wherein the holder containing a bore; and when the fan tool and holder are assembled, the shank portion of the fan tool being positioned within the bore so that a rearward length of the shank extending rearwardly of the holder, and a nut threadedly engages the threaded shank so as to affix the fan tool to the holder.

8. The non-rotatable fan tool-holder assembly of claim 7 wherein the wear member comprises hard particles in a matrix.

9. The non-rotatable fan tool-holder assembly of claim 7 wherein the wear member having a generally planar forward face, the shank portion having a longitudinal axis, and the forward face of the wear member being disposed at an included angle with respect to the longitudinal axis of the shank portion.

10. The non-rotatable fan tool-holder assembly of claim 9 wherein the included angle ranges between about 0 degrees and about 90 degrees.

11. The non-rotatable fan tool-holder assembly of claim 9 wherein the included angle ranges between about 30 degrees and about 75 degrees.

12. A fan tool for use in conjunction with a tool holder containing a notch, the fan tool comprising:
a head portion and a shank portion;
the head portion having a support member and a wear member containing hard particles, the wear member being integral with the support member, the support member having a rear surface from which there protrudes a protrusion wherein the protrusion engages the notch so as to render the fan tool non-rotatable with respect to the holder;
the wear member extending over the protrusion;
the shank portion having an axial forward end;
the shank portion being attached at the axial forward end thereof to the rear surface of the head portion; and
the wear member having a generally planar forward face, the shank portion having a longitudinal axis, and the forward face of the wear member being disposed at an included angle with respect to the longitudinal axis of the shank portion wherein the included angle ranges between about 0 degrees and about 90 degrees.

15. The fan tool of claim 14 wherein the included angle ranges between about 30 degrees and about 75 degrees.
